(19) United States
(12) Patent Application Publication
(10) Pub. No.: US 2006/0218282 A1
(43) Pub. Date: Sep. 28, 2006

(54) System and method for providing mobile assisted, fixed line video calls

(75) Inventors: Jaakko Teinila, Espoo (FI); Jari Selin, Espoo (FI); Mikko Lonnfors, Helsinki (FI); Kai Vehmanen, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/088,379

(22) Filed: Mar. 23, 2005

(51) Int. Cl. G06F 15/16

(52) U.S. Cl. 709/227

(57) ABSTRACT

A system and method for providing mobile assisted, fixed line communication. A device connectable to a mobile network coordinates with a session gateway device that is connected to a fixed line network in order to establish a connection to another gateway device. Signaling over a cellular or other non-fixed line network is used to establish connection parameters relating to a fixed line session. The established connection parameters are transmitted to the respective session gateway devices. Based upon these parameters, the session gateway devices can directly communicate with each other over the Internet or other fixed line network.

### FIELD OF THE INVENTION

The present invention relates generally to the field of session establishment. More particularly, the present invention relates to the establishment and maintenance of video communications within a combined environment of mobile and fixed line networks.

### BACKGROUND OF THE INVENTION

Over past years, the level of technology in the field of video conferencing has advanced significantly. In recent years video conferencing has become very common in business settings, permitting meetings to take place in an interconnected manner in multiple locations around the world. Developments have also been made in the area of “video” telephone calls. However, although video conferencing and video calling have improved recently, they still suffer from several drawbacks.

In the Internet, it is difficult to make point-to-point connections between individual users and/or user devices. The main reason for this difficulty is the fact that there are currently no global identifiers for users within the Internet that can be utilized to create a connection. For example, electronic mail addresses are global, but they do not identify a current user of a device. Although internet protocol (IP) addresses are used in the Internet, IP addresses are not always static in nature. Instead, parts of IP address space are allocated dynamically, which means that IP addresses are of limited use for identifying network nodes. Also, IP addresses serve as location information for machines, not for users. Additionally, there are currently no directory services available in the Internet that enable a person or a device to request an IP address of a specific individual person. Furthermore, video calls also currently often require that the two call participants use the same service provider, and the participants'communication parameters and firewall arrangements must be precisely prepared before a working session can be established. Therefore, even though there is sufficient bandwidth on the Internet to allow the making of video calls over the Internet, it is difficult to use the Internet for such calls due to this lack of addressability.

On the other hand, within telecommunication networks, there are globally reachable addresses available to users. These addresses currently take the form of telephone numbers according to the ITU-T E. 164 standard and, in the future, Session Initiation Protocol (SIP) addresses will also be available. The Session Initiation Protocol is an Internet engineering Task Force standard protocol for establishing, modifying and tearing down interactive sessions that involve multimedia elements such as audio, video, instant messaging, or other real time data communications.

The availability of telephone numbers and SIP addresses enables telecommunication users to establish sessions, such as voice calls, or to send messages, such as short messaging system (SMS) messages or instant messages (IMs) between users. However, in mobile networks, there is usually not enough bandwidth to conduct high quality, real time sessions for video calls. Furthermore, even if sufficient bandwidth was readily available, such as in wideband code division multiple access (WCDMA) networks, the cost of such bandwidth sessions could be prohibitive.

Another problem related to video calls in mobile devices is the small display size. In most mobile devices currently available, there are not enough pixels on the display screen to show high quality video, and the physical size of the display adversely affects usability and the impressiveness of the video call.

### SUMMARY OF THE INVENTION

The present invention provides for an improved system and method for enabling communication between terminals by taking advantage of the best aspects of both fixed line Internet networks and mobile networks. Devices connectable to a mobile network are used to establish connections between devices connected to a fixed line network. Telecommunications signaling is used in the first phase of the connection process between two users. This signaling is used to negotiate connection parameters relating to a fixed line session. A second phase involves the communication of the parameters to the respective devices that are connected to the Internet or other fixed line system. Based upon these parameters, the device that is connected to the Internet or other fixed line network can establish a session with the other endpoint connected to the Internet or other fixed line network.

The present invention provides for a number of benefits to users of the system. The present invention eliminates the issue of a lack of globally routable IP addresses associated with the Internet, while also taking advantage of the Internet's high-bandwidth capabilities.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a generic system within which the present invention may be implemented;

FIG. 2 is a system exhibiting one embodiment of the present invention;

FIG. 3 is a perspective view of a mobile telephone that can be used in the implementation of the present invention;

FIG. 4 is a schematic representation of the telephone circuitry of the mobile telephone of FIG. 3; and

FIG. 5 is a flow chart showing the implementation of one embodiment of the present invention.

### DETAILED DESCRIPTION OF THE PREFERRED EMBODIMENTS

The present invention provides an improved system and method for enabling video calling between users by taking advantage of the benefits inherent in both mobile networks and fixed line networks such as the Internet.

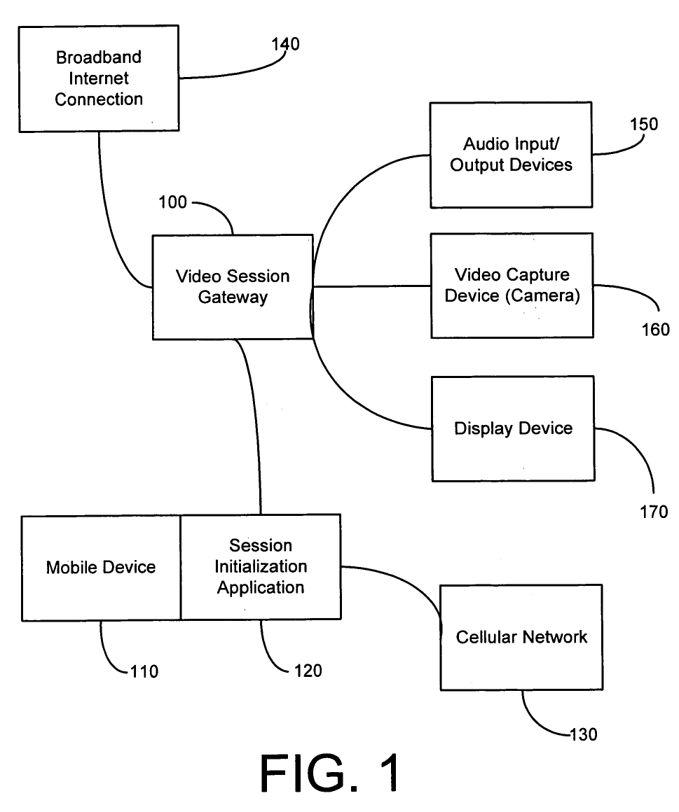

FIG. 1 is a representation of a generic system within which the present invention may be implemented. The system of FIG. 1 includes a video session gateway device 100, also referred to as a video telephony gateway device, with a broadband connection 140 associated therewith. The video session gateway device 100 has Internet connectivity and is configured so as to be capable of establishing a video session with another video session gateway device 100 over the broadband connection 140 using, for example SIP signaling, and normal video codecs.

The video session gateway device 100 communicates with a mobile telephone 110 or other mobile device over a local link. The local link can take a variety of forms, such as a Bluetooth connection, a wireless local area network (WLAN) connection, a cable connection or others. The video session gateway device 100 captures a video stream from a video capture device 160, such as a camera or other data capturing device, or signals the session parameters to the video capture device 160. The video session gateway device 100 also includes a video output for transferring video to be shown on a display device 170, such as an integrated display, or a similar data rendering device. It should also be noted that, in a case where a user does not have a separate video session gateway device 100, the mobile telephone 110 or other mobile device can serve as the video session gateway device 100.

The broadband connection 140 can take the form of an Asymmetric Digital Subscriber Line (ADSL) or some other type of Internet connection that enables a high quality video connection. The video capture device 160 serves as the camera for the video call. The video capture device 160 can be connected to the video session gateway device as an accessory, it can be part of the video session gateway device 100, or it can be a standalone web-cam connected to internet.

The display device 170 is used to show the video call. The display device 170 can take a variety of forms. For example, the display device 170 can be a regular television, a dedicated display, or an integrated display. A variety of audio input/output devices 150 can also be connected to the video session gateway device 100.

The mobile device 110 includes a session establishment application 120 to set up the preliminary connection between users using signaling systems, such as SMS, multimedia message service (MMS), SIP or others, over the cellular network 130 of the mobile device 110. The mobile device 110 communicates with the video session gateway device 100 over the local link. In other words, the mobile device transmits video session parameters to the video session gateway device 100 after the session parameters have been preliminarily negotiated between mobile devices.

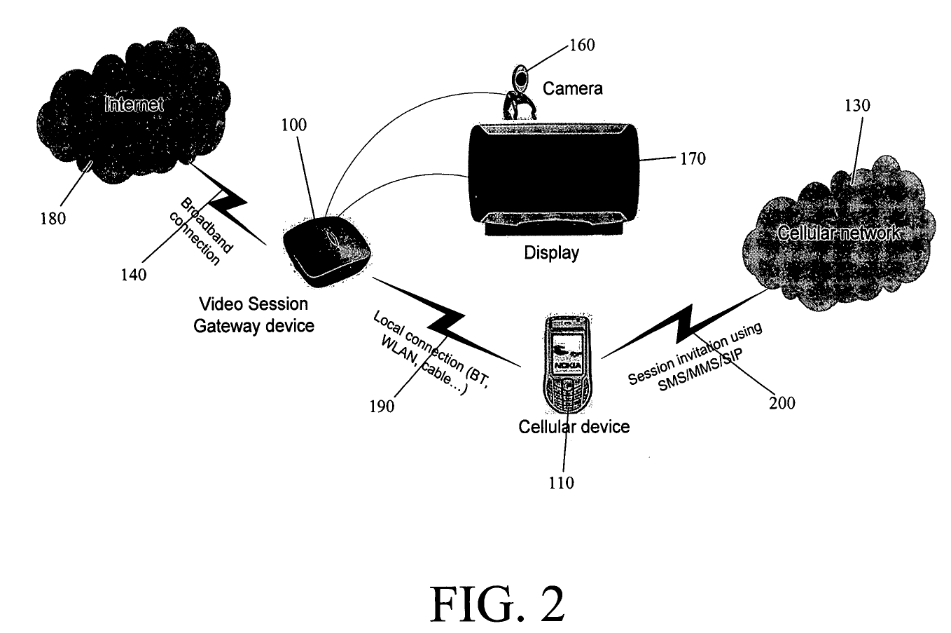

FIG. 2 is a system that shows additional detail of one embodiment of the present invention. FIG. 2 shows the video session gateway device 100 connected to the Internet 180 via a broadband connection 140. A local connection 190 connects the video session gateway device 100 to a mobile telephone 110. The mobile telephone 110 transmits session invitations to a potential recipient via its respective cellular network 130 through the use of session invitations 200. A camera/video capture device 160 and a display 170 are also operatively connected to the video session gateway device 100.

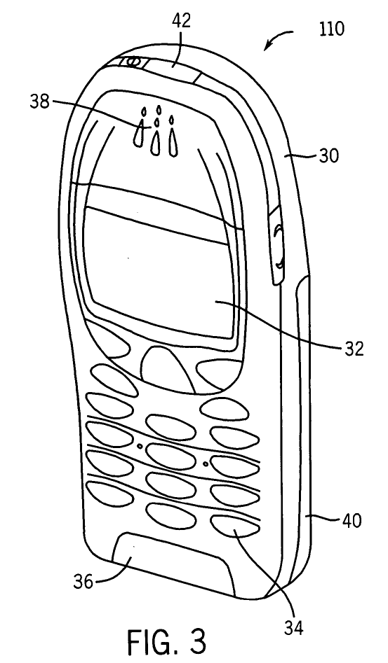

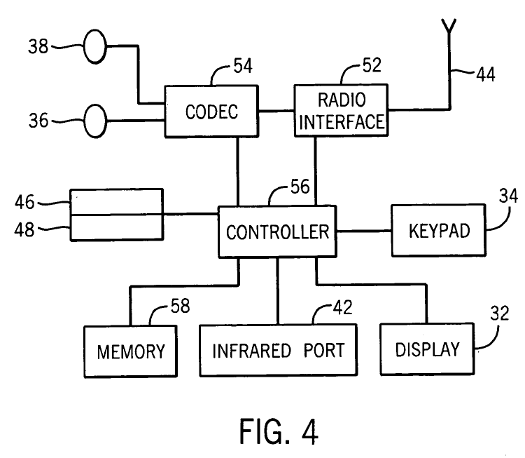

FIGS. 3 and 4 show one representative mobile telephone 110 within which the present invention may be implemented. It should be understood, however, that the present invention is not intended to be limited to one particular type of mobile telephone 110 or other electronic device. For example, the present invention can be incorporated into a combination personal digital assistant (PDA) and mobile telephone, a PDA, an integrated messaging device (IMD), a desktop computer, and a notebook computer. The mobile telephone 110 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a system clock 43, a card reader 48, radio interface circuitry 52, codec circuitry 54, a controller 56 and a memory 58. A motion sensor 60 is also operatively connected to the controller 56. Individual circuits and elements are all of a type well known in the art, for example in the Nokia range of mobile telephones.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

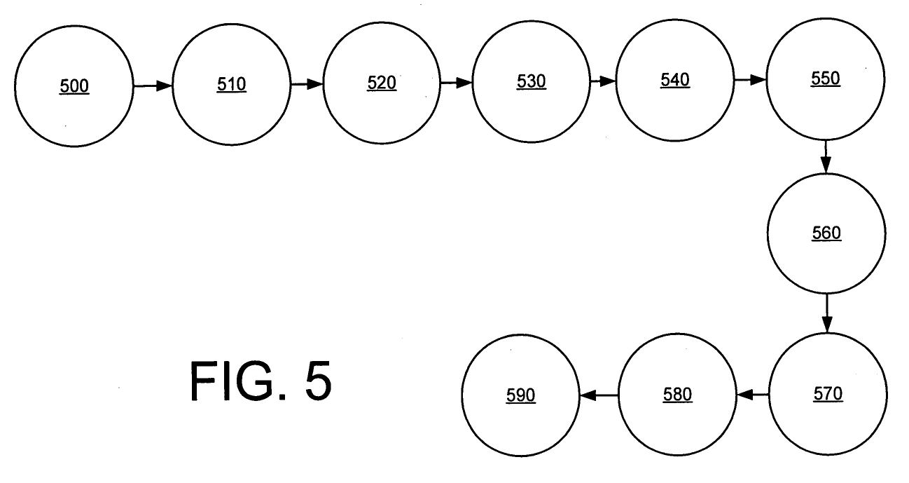

FIG. 5 is a flow chart showing the steps involved in one implementation of the present invention. At step 500, a first user initiates a session establishment application in his or her mobile telephone 110 or other terminal. At this time, the first user should be in a location so that the first user's terminal and the first user's video session gateway device 100 are in the same general vicinity. At this point, the establishment application displays the first user's phonebook entries. At step 510, the first user selects a phonebook entry for a second user. At step 520, the selection triggers a specific invitation message to be sent to the second user's terminal. The specific invitation message can take a variety of forms, including, but not limited to a SMS message. This invitation can also include address information or other parameters for the first user's video session gateway device 100. At step 530, the second user's terminal receives the invitation and, at step 540, a session establishment application is initiated. The session establishment application informs the second user that there is a video call invitation from the first user.

At step 550, the second user accepts the invitation. At step 560, the second user's terminal requests communication parameters from its video session gateway device 100 over the local link and builds a specific reply message to be sent to the first user's mobile telephone. This reply includes the requested communication parameters, which include, for example, an IP address, DNS name, or protocol- and application-level information such as TCP/UDP port or codec version. The second user's terminal can also include its own communication parameters in the reply message in a situation where the second user desires that the video connection is to be transmitted directly to the second user's terminal. The reply message is transmitted at step 570. At step 580, the first user's mobile telephone informs the first user that the second user has accepted the call. At step 590, the first user's mobile telephone transfers the communication parameters to its video session gateway device 100 over the respective local link. At this point, the first and second users are ready to start an actual video session between the respective video session gateway devices using the received communication parameters. The session can be established using, for example, SIP signaling and normal video codecs. A television or other display device can be used for the received video. At this point, if both the first and second users are using video session gateway devices, the respective mobile terminals are no longer necessary for the call to proceed. Alternatively, it is also possible that a portion of the media is continued to be transmitted over the cellular network, while the rest of the media is transmitted over the fixed line network. For example, it is possible for the fixed line network to carry the video transmission between the parties, while the cellular network carries the audio transmission.

In the video telephony case, it should be noted that many of the functionalities of the present invention can be combined as necessary or desired. For example, the gateway functionality can be incorporated into a mobile telephone 110. As an example only, a the mobile telephone can include WLAN and TV-out interfaces, permitting the mobile telephone to serve as the video system gateway device. Other arrangements are also possible for combining various functionalities.

Furthermore, it should also be noted that the present invention is not strictly limited to communication involving video telephony, but instead can be for virtually any type of mobile-assisted session establishment. For example, the present invention can also be used to establish video gaming sessions and other types of sessions.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for enabling communication between multiple users, comprising the steps of:
transmitting an invitation over non-fixed line network from a first system to a second system;
receiving a response to the invitation from the second system, the response including communication parameters for a second system gateway device;
providing the communication parameters to a first system gateway device; and
establishing a communication link from the first system gateway device to the second system gateway device.

2. The method of claim 1, wherein the communication link is established from the first system gateway device to the second system gateway device over the Internet.

3. The method of claim 1, wherein at least one of the first system gateway device and the second system gateway device comprise a mobile telephone.

4. The method of claim 1, wherein the communication between the first system gateway device and the second system gateway device comprises video communication, and further comprising providing audio communication over the non-fixed line network between a first system electronic device and the second system.

5. The method of claim 4, wherein a second system electronic device receives the invitation from a first system electronic device and transmits the address information of the second system gateway device to the first system electronic device.

6. The method of claim 1, wherein the communicating between the first system gateway device and the second system gateway device includes transmitting data received by the first system gateway device from the second system gateway device to a data rendering device.

7. The method of claim 1, wherein the communicating between the first system gateway device and the second system gateway device includes transmitting data received by the first system gateway device from a data capturing device to the second system gateway device.

8. A computer program product for enabling communication between multiple users, comprising:
computer code for transmitting an invitation from a first system to a second system over a non-fixed line network, the first system including a first system gateway device;
computer code for receiving address information for a second system gateway device from the second system in response to the invitation;
computer code for providing the address information to the first system gateway device; and
computer code for permitting communication between the first system gateway device and the second system gateway device over a fixed line network.

9. The computer program product of claim 8, wherein the compute code for communicating between the first system gateway device and the second system gateway device includes computer code for transmitting data received by the first system gateway device from the second system gateway device to a data rendering device.

10. The computer program product of claim 8, wherein the communicating between the first system gateway device and the second system gateway device includes computer code for transmitting data received by the first system gateway device from a data capturing device to the second system gateway device.

11. The computer program product of claim 8, wherein a first system electronic device transmits the invitation to the second system and receives the address information from the second system.

12. The computer program product of claim 8, wherein the communication between the first system gateway device and the second system gateway device comprises video communication, and further comprising computer code for providing audio communication over the non-fixed line network between a first system electronic device and the second system.

13. The computer program product of claim 8, wherein at least one of the first system gateway device and the second system gateway device comprises a mobile telephone.

14. An electronic device within a first system for enabling communication with a second system, comprising:
a processor;
a communication link for permitting interaction with a non-fixed line network; and
a memory unit operatively connected to the processor, the memory unit including:
computer code for transmitting an invitation to the second system through the non-fixed line network,
computer code for receiving address information for a second system gateway device from the second system in response to the invitation;
computer code for, upon receiving the address information, transmitting the address information to a first system gateway device; and
computer code for permitting communication between the first system gateway device and the second system gateway device over a fixed line network.

15. A system for enabling communication between multiple users, comprising:
a first electronic device;
a first gateway device in communication with the first electronic device;
a second electronic device in communication with the first electronic device over a non-fixed line network; and
a second gateway device in communication with the first electronic device,
wherein, upon the receipt of an invitation from the first electronic device, the second electronic device obtains address information for the second gateway device for transmittal to the first electronic device, and wherein the first gateway device uses the address information to directly communicate with the second gateway device over a fixed line network.

16. The system of claim 15, further comprising a camera in communication with the first gateway device for capturing images to be transmitted to the second gateway device.

17. The system of claim 15, further comprising a display for exhibiting information transmitted to the first gateway device from the second gateway device.

18. The system of claim 15, wherein the fixed line network comprises the Internet.

19. The system of claim 15, wherein at least one of the first electronic device and the second electronic device comprises a mobile telephone.

20. The system of claim 15, wherein the first electronic device communicates with the first gateway device over a local area network.
